(19) United States
(12) Patent Application Publication
(10) Pub. No.: US 2023/0241793 A1
(43) Pub. Date: Aug. 3, 2023

(54) CUTTING DEVICE FOR CUTTING CAPS AND RELATIVE ASSEMBLY METHOD

(71) Applicant: SACMI COOPERATIVA MECCANICI IMOLA SOCIETA' COOPERATIVA, Imola (BO) (IT)

(72) Inventor: Matteo VENTURINI, Imola (IT)

(21) Appl. No.: 18/159,979

(22) Filed: Jan. 26, 2023

(30) Foreign Application Priority Data
Feb. 1, 2022 (IT) 102022000001724

(51) Int. Cl. B26D 1/00; B26D 1/02; B26D 3/08; B26F 1/18

(52) U.S. Cl. CPC B26D 1/0006; B26D 1/02; B26D 3/08; B26F 1/18; B26F 2210/04; B26D 2001/0033; B26D 2001/004; B26D 2001/0053

(57) ABSTRACT

A cutting apparatus and a cutting device are disclosed including a modular insert arranged at least partially in a housing cavity, in which the modular insert includes a cutting element for performing a vertical or oblique cut and an abutting block which is interchangeable and couplable with the cutting element to fix a total dimension of the modular insert, in which an abutting face of the abutting block abuts on a back wall of the housing cavity so that a rear end of the cutting element is spaced away from the back wall. An assembly method is disclosed for assembling the aforesaid device including the steps of providing a plurality of interchangeable abutting blocks and of choosing an abutting block between the plurality of interchangeable abutting blocks on the basis of a desired total dimension of the modular insert.

### BACKGROUND OF THE INVENTION

The invention relates to a cutting device for cutting caps or plugs, for example made of plastics, of the type used for closing containers like, for example, bottles. In particular, the invention relates to a device for making at least one circumferential incision (at least for a part of a circumference or for an entire circumference) on a cap, and at least one vertical or oblique incision.

Specifically, but not exclusively, the invention in question can be used to make cuts or incisions to make so-called tethered caps, or caps that remain attached to the container even after opening.

For such caps, one or more horizontal blades and one or more blades with tilted or vertical portions are normally arranged.

The cuts made enable a tamper ring or band or connecting portions (like for example belts, or straps, or hinges, etc) to be made in the body of the cap between a tamper ring and a side wall of the cap or other cap portions to be defined.

Specifically, but not exclusively, the cutting device in question can be provided inside a cutting apparatus for cutting caps.

The invention in question also relates to an assembly method of the cutting device.

Cutting apparatuses are known with a carousel structure that rotates a plurality of gripping spindles of the caps fitted to the periphery of the carousel, spaced angularly apart from one another, each rotatable on itself. Each spindle rotates the cap on itself and conveys the cap along a circular advancement path, through one or more zones in which known cutting devices are arranged that make an incision on or cut the side wall of the cap. The cutting devices consist of a plurality of cutting parts and/or of support parts that have reduced dimensions, compatible with the dimensions of the incisions on the caps to make a tethered cap.

Several aspects of the prior art are improvable.

Firstly, it is desirable to make incisions on the caps precisely and repeatably.

Secondly, it is auspicable to provide a limited number of parts of the cutting device, particularly of the cutting parts for vertical or oblique incisions, so as to limit maintenance and product-change time.

It is also desirable that an operator has available the spare parts for maintenance and/or for a production change so as to limit the time for procuring components of the cutting device.

Thirdly, it is auspicable to provide a cutting device in which the various components are easy for a user to handle.

In addition, is auspicable to provide a cutting device that is flexible for a production change or for compensating for wear to the cutting parts.

It is further auspicable to provide a method for fitting a cutting device that is simple, rapid, and intuitive.

### SUMMARY OF THE INVENTION

One object of the invention is to improve cutting apparatuses and cutting devices of known type for cutting caps.

One object is to provide an apparatus and/or a device that is able to overcome one or more of the aforesaid limits and drawbacks of the prior art.

One object is to provide an alternative apparatus and/or an alternative device for cutting caps to those of the prior art.

One object is to provide a fitting method for a cutting device that is simple, rapid, and intuitive.

One advantage is to improve the cutting quality of the blades used, in particular, for cutting tethered caps, i.e. blades that have vertical or oblique portions.

One advantage of the invention is to provide a device that is simple to fit and handle.

One advantage of the invention is to ensure correct execution of the cuts made on the caps.

One advantage is to make available a device and/or a cutting apparatus for cutting caps that is constructionally simple and cheap.

One advantage is to make available a cutting device and/or a cutting apparatus to make incisions on caps that is compact in dimensions.

A further advantage is to provide a cutting device that is standardized, i.e. suitable for serial production, and which is modular.

Other advantages are compensating for wear to components of the device for making incisions on caps and reducing rejects in the production of caps provided with incisions.

These objects and advantages, and still others, are achieved by a cutting apparatus and/or a cutting device and/or an assembly method according to one or more of the claims set out below.

In one embodiment, a cutting device includes at least one modular insert arranged at least partially in a housing cavity, said at least one modular insert including a cutting element with a cutting edge for making at least one vertical or oblique cut on the cap, said at least one modular insert including an interchangeable abutting block that is couplable with the cutting element to fix a total dimension of the modular insert and that includes an abutting face that abuts on a back wall of the housing cavity so that a rear end of the cutting element is spaced away from the back wall.

The cutting device may be included, in particular, in a cutting apparatus that includes a carousel provided with a plurality of conveying units each configured to engage the cap and convey the cap to the cutting device.

In one embodiment, an assembly method for assembling the aforesaid device may include, in particular, the steps of providing a plurality of interchangeable abutting blocks and of choosing an abutting block from the plurality of interchangeable abutting blocks on the basis of a desired total dimension of the abutting block so that a rear end of the cutting element opposite the cutting edge is spaced away from the back wall by a desired distance.

### BRIEF DESCRIPTION OF THE DRAWINGS

The invention can be better understood and implemented with reference to the attached drawings that illustrate some embodiments thereof by way of non-limiting example, in which:

FIG. 1 is an axonometric view of a first embodiment of the cutting device in which a cap and an advancement path of the cap is shown schematically;

FIG. 2 is an exploded axonometric view of the cutting device of FIG. 1 that shows a first horizontal blade, a second horizontal blade and a support body;

FIG. 3 is an enlargement of FIG. 2 in which the support body is shown in greater detail in which modular inserts are inserted;

FIG. 4 is an enlargement of FIG. 1 in the same region as the cutting device illustrated in FIG. 3, in which modular inserts are shown in an exploded view with their abutting blocks and cutting elements and respective housing cavities;

FIG. 4a is a plan view of a decoupled modular insert in which the respective cutting element has a cutting edge sharpened on two sides;

FIG. 5 is a plan view of two modular inserts each inserted into the respective housing cavity with a desired overall dimension thereof,

FIG. 6 is an axonometric view of a second embodiment of the cutting device that shows a first horizontal blade, a second horizontal blade and a support body;

FIG. 7 is a plan view of the support body of FIG. 6 into which two modular inserts are inserted;

FIG. 8 is an axonometric view of a third embodiment of the cutting device in which cutting elements have tilted cutting edges;

FIG. 9 is an exploded axonometric view of the cutting device of FIG. 8 that shows a first horizontal blade, a second horizontal blade and a support body with two modular inserts inserted;

FIG. 10 is a plan view of several abutting blocks that are suitable for forming modular inserts having desired overall dimensions that are different from one another;

FIGS. 11 and 12 are plan views of the modular inserts in FIG. 9 each having their own overall desired dimension;

FIG. 13 is a plan view of a cutting apparatus for cutting caps in which a spindle-holding carousel, conveying spindles and a cutting zone are shown in which a cutting device is arranged.

### DETAILED DESCRIPTION

With reference to the aforementioned figures, a cutting device 1, 1′, 1″ is disclosed that is arranged for cutting (or making incisions on) a cap 2 (or a plug), the cap rolling on a cutting portion of the cutting device 1, 1′, 1″ in an advancement direction T. The caps 2 are usable, in particular, for closing containers, for example bottles. The cutting portion includes cutting edges arranged according to different tilts with respect to the advancement direction T. The numeric references 1, 1′, 1″ refer to several embodiments of the cutting device the differences of which are explained below in this description.

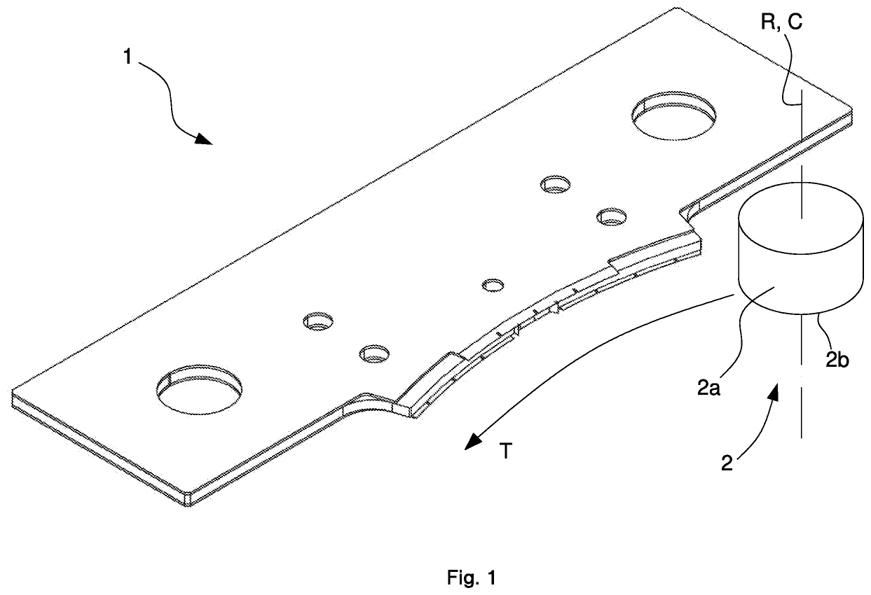

The cap 2 may include, in particular, a cup-shaped body with a base wall 2b that defines a closed end of the cup-shaped body (FIG. 1). The base wall 2b includes an inner face and an outer face that are opposite to one another. The base wall 2b may be, in particular, disc-shaped and may include a central region traversed by a longitudinal axis C that may be, in particular, orthogonal to the base wall 2b, and a peripheral region near a peripheral edge of the disc and further from the longitudinal axis C with respect to the central region. The cap 2 may include, in particular, a side wall 2a contiguous to the base wall 2b that extends around the longitudinal axis C of the cap as far as a free edge of the base wall 2b, which free end defines an open end of the cup body. The side wall 2a may be, in particular, a cylindrical side wall that is coaxial with the longitudinal axis C.

The cap 2 may include, in particular, at least one circumferential incision intended to separate the cap 2 into a main body that includes the closed end of the cap 2, and into a tamper band including an open annular portion of the cap. The circumferential incision may include, in particular, a plurality of facilitated breakage lines, or weakening lines, that may be arranged on the cap 2 according to various tilts with respect to the longitudinal axis C, to define on the cap the main body, the tamper band and a connecting portion that connects the main body to the tamper band, i.e. a strap.

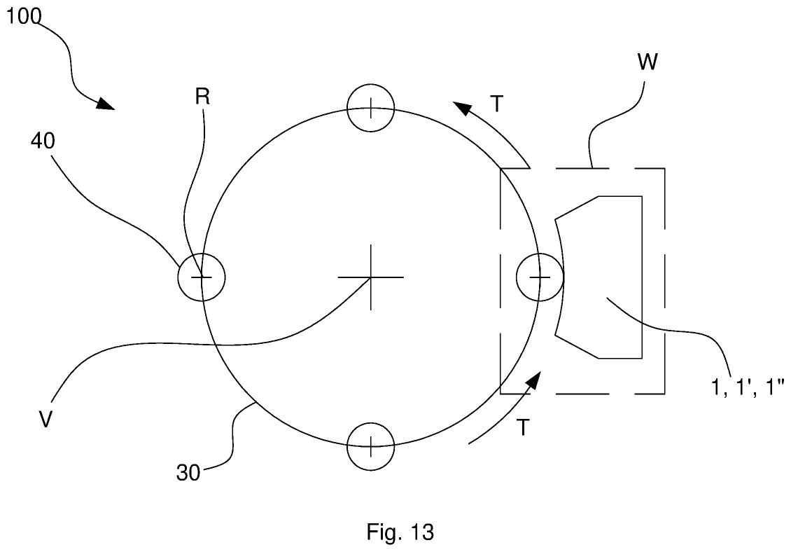

The cutting device 1, 1′, 1″ may be included (and used) in a cutting apparatus 100 for making incisions on caps 2 (FIG. 13). The cutting apparatus 100 may include, in particular, an advancement path that is transitable by the cap 1, in particular along the advancement direction T. This advancement path may include, in particular, a circumference arc and may be defined in a peripheral zone of a spindle-holding carousel 30 (included in the cutting apparatus) that in one embodiment rotates around a vertical axis of revolution V, in particular orthogonal to a horizontal base of the apparatus, and rotates a plurality of conveying units 40 around the vertical axis of revolution V, each of the conveying units 40 being arranged to engage and move the cap 2. In an alternative embodiment that is not illustrated, the axis of revolution V is horizontal. In other words, in this alternative embodiment, the axis of revolution V may be in particular substantially parallel to the horizontal base of the apparatus. In a further alternative embodiment of the apparatus, the axis of revolution V may be tilted by an angle comprised between 0 and 90 sexagesimal degrees with respect to the horizontal base of the apparatus. The advancement path is arranged adjacent and parallel alongside the cutting portion of the cutting device 1. The advancement path faces the cutting portion.

Each conveying unit 40 may include, in particular, a conveying spindle that is rotatable around a rotation axis thereof R (FIGS. 1 and 13) and shaped to interact with the cap 2 to feed the cap 2 along the advancement path. The rotation axes R of the various spindles may be, in particular, vertical, or anyway parallel, to the axis of revolution V of the carousel 30.

The rotation axis R of the spindle may be substantially parallel to, in particular coaxial with, the longitudinal axis C of the cap 2 (FIG. 1).

The cutting apparatus 100 may include a cutting zone W reached and traversed by the conveying unit 40 (or by the conveying spindle) during operation of the cutting apparatus (FIG. 13). The cutting apparatus 100 further includes an inlet or supply zone upstream of the cutting zone W, and an unloading zone downstream of the cutting zone W.

The cutting device 1, 1′, 1″, is arranged in the cutting zone W to make an incision on the cap 2.

With the numeric reference 1, a first embodiment of the cutting device is indicated; for the sake of simplicity, reference will be made to this embodiment in the description, unless otherwise specified. Further, the parts common to the embodiments 1, 1′, 1″ will be indicated with the same numeric references.

The cutting device 1 may include, in particular, a support member arranged for supporting at least one horizontal blade 3, 4 to perform at least one circumferential cut on the cap. The support member may include, in particular, a support block and/or a support plate.

The cutting device 1 may include, in particular, the at least one horizontal blade 3, 4. “Horizontal” means that the blade is arranged substantially parallel to the advancement direction T (which is in fact generally horizontal) of the cap. The at least one horizontal blade may include, in particular, one or more horizontal cutting edges.

The cutting device 1 may include, in particular, at least one modular insert 5 that is supported by the support member to perform at least one vertical or oblique cut on the cap. In the context of the invention, “vertical” means that a cutting edge of the modular insert 5 is arranged substantially orthogonal to the advancement direction T. “Oblique” or “tilted” means that a cutting edge of the modular insert 5 is arranged transversely to the advancement direction T.

The modular insert 5 may include, in particular, a cutting element 6 provided at one end with a cutting edge 7. The cutting element 6 is provided with a rear end 14 that is opposite the cutting edge 7. The cutting element 6 extends along a main direction M. The cutting element 6 may have, in particular, an elongated shape. The cutting element 6 may include, in particular, a coupling protrusion 16 that is transverse, in particular orthogonal, to the main direction M.

The modular insert 5 may include, in particular, at least one interchangeable abutting block 8 that is couplable with the cutting element 6 to fix an overall desired dimension D of the at least one modular insert 5. The abutting block 8 is provided with an abutting face 12 that will be disclosed below. The overall desired dimension D of the modular insert 5 may be defined as a length measured between the cutting edge 7 and the abutting face 12.

In the specific embodiments shown in the figures, each modular insert 5 consists of two pieces, the cutting element 6 and the abutting block 8.

The support member may include, in particular, a support body 9 arranged for supporting the modular insert 5. The support body may include, in particular, on a peripheral edge 10 thereof, per each modular insert 5, a housing cavity 11. The housing cavity 11 is shaped, in particular, for receiving partially the modular insert 5 such that the cutting edge 7 protrudes from the peripheral edge 10 of the support body 9.

The support body 9 may be, in particular, plate shaped. In other words, the support body may have the shape of a foil the main dimensions of which (width and length) are significantly greater than a cross section (thickness).

The modular insert 5 is insertable into and removable from the housing cavity 11. In particular, the modular insert 5 is insertable into and removable from the housing cavity 11 along a direction parallel to the cross section of the support body 9.

The abutting block 8 is provided with an abutting face 12 configured to abut on a back wall 13 of the housing cavity 11 such that the rear end 14 of the cutting element 6 is spaced away from the back wall 13. In particular, with reference to the abutting block 8 inserted into the housing cavity 11, the rear end 14 is far from the back wall by a distance F (FIG. 5), the distance F being measured along the main direction M. Different distances F correspond to different abutting blocks 8.

As, during operation of the cutting device 1, the peripheral edge 10 faces the cap 2, the protrusion of the cutting edge 7 contributes to determining the depth of the cut on the cap 2. The protrusion of the cutting edge 7 extends transversely to the advancement direction T. In particular, considering the cutting apparatus 100, in particular the carousel 30, the protrusion of the cutting edge 14 extends to a central region of the carousel 30 (where there is the axis of revolution V) along a radial direction, where “radial” means with respect to the axis of revolution V of the carousel 30 (FIG. 13).

When the modular insert 5 is inserted into the housing cavity 11 the abutting face 12 of the abutting block 8 rests on the back wall 13. In this situation, the overall desired dimension D of the modular insert 5 determines the protrusion of the cutting edge 7.

The cutting device 1 may include, in particular, at least two interchangeable abutting blocks 8 to obtain desired overall dimensions D that are different from one another. This enables the protrusion of the cutting edge 7 from the peripheral edge 10 to be varied on the basis of the abutting block 8 selected to make up the modular insert 5.

With reference to FIG. 5, two abutting blocks 8, 8′ may be provided, each of which is suitable for forming a modular insert 5 having respectively desired overall dimensions D, D′.

If the cutting edge 7 is worn, the total dimension of the modular insert 5 is reduced with respect to the overall desired dimension D, in the same manner also the protrusion of the cutting edge 7 from the peripheral edge 10 is reduced. In this case, by maintaining the same worn cutting element 6, the abutting block 8 may be replaced to restore the protrusion of the cutting edge 7.

The abutting block 8 and the cutting element 6 are couplable together by shape coupling. The abutting block 8 may include, in particular, a coupling protrusion 16 that is arranged for being inserted at least partially into the coupling slot 15 to form the modular insert 5. The shape coupling between the coupling protrusion 16 and the coupling slot 15 prevents movement between the abutting block 8 and the cutting element 6 at least parallel to the main direction M.

The abutting block 8 includes a main body. The main body may have a polyhedral, in particular parallelepipedon shape. The abutting face 12 is obtained on an external surface of the main body. The coupling protrusion 16 extends from the main body. The coupling protrusion 16 may have a polyhedral, in particular parallelepipedon shape. In one embodiment that is not illustrated, the protrusion may include a pin arranged for being inserted into a corresponding coupling slot obtained in the cutting element.

The abutting face 12 may include, in particular, a flat surface (as in the illustrated embodiments). In one embodiment that is not illustrated, the abutting face 12 may include a curved surface to abut on a respective curved back wall of the housing cavity.

A distance H may be defined between the abutting face 12 and the coupling protrusion 16. This distance H may be measured along a direction parallel to the main direction M (or along the radial direction). The interchangeable abutting blocks 8, 8′ may have distances H, H′ between the coupling protrusion 16 and the abutting face 12 that are different from one another (FIG. 5). Again, with reference to FIG. 5, the interchangeability of the abutting blocks 8, 8′ enables a modular insert 5 to be composed having a further different overall desired dimension D′ (in the specific embodiment less than the overall dimension D) coupling for example the same cutting element 6 with a further abutting block 8′ the distance H′ thereof is different (in the specific embodiment less) than the distance H of the abutting block 8. As mentioned, to compensate for wear to the cutting edge 7, the same overall desired dimension D may be maintained by coupling a worn cutting element 6 with an abutting block having a greater distance H.

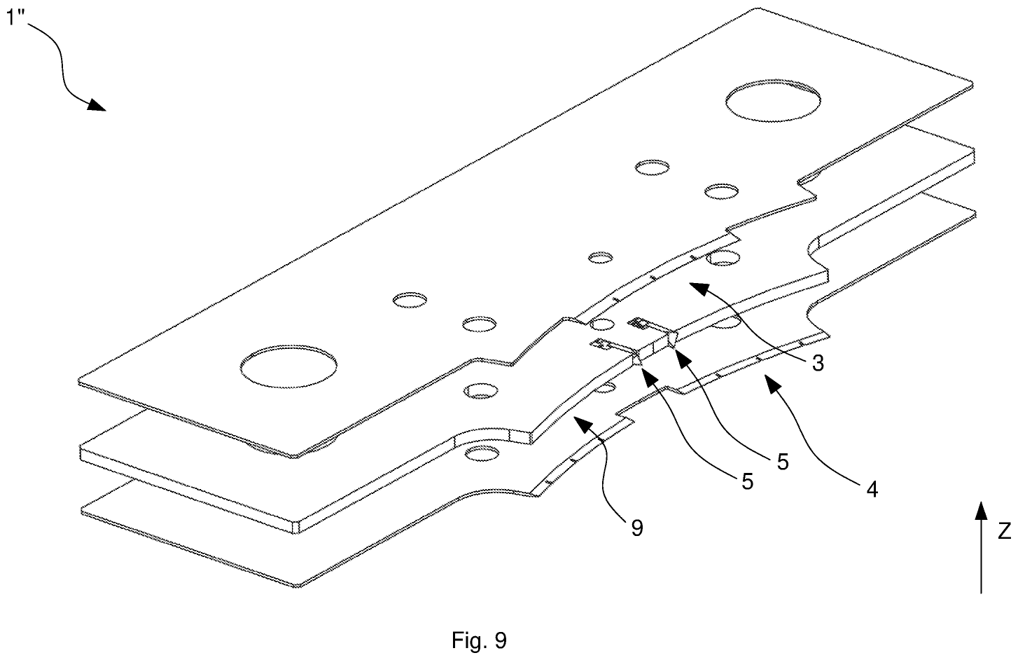

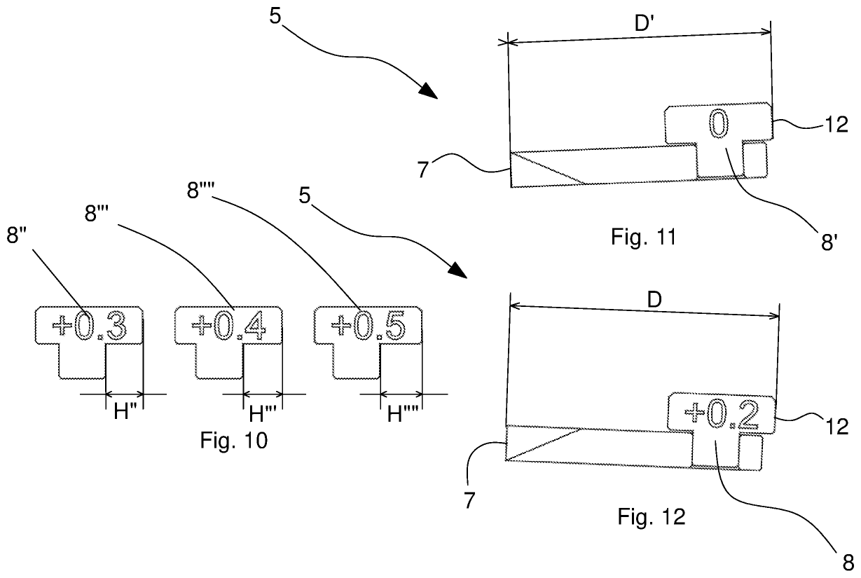

In the cutting device, a plurality of abutting blocks 8, 8′, 8″, 8′, 8″″ may be provided that are different from one another having respective distances H, H′, H″, H′″, H″″ which are also different from one another. In the example illustrated in FIGS. 5, 10. 11 and 12 five abutting blocks 8, 8′, 8″, 8′″, 8″″ are provided that are different from one another. In an alternative embodiment, several abutting blocks that are different from one another may be provided, for example two, or three, or four abutting blocks that are different from one another. In a further alternative embodiment, several abutting blocks may be provided that are different from one another, for example six, or seven, or eight or nine or ten, abutting blocks that are different from one another. N abutting blocks may be provided that are different from one another, where N is a whole number.

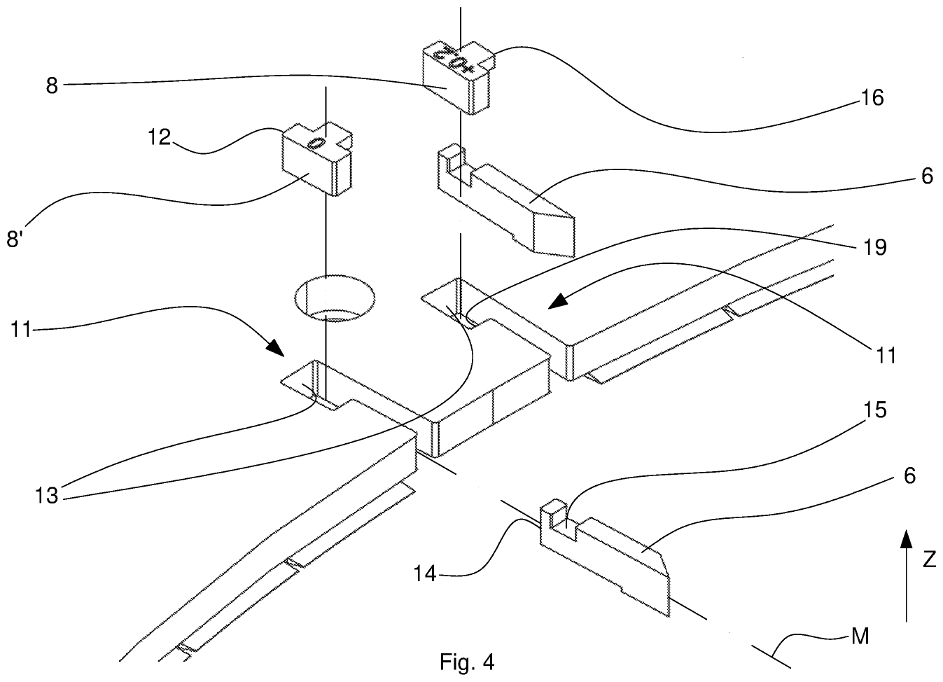

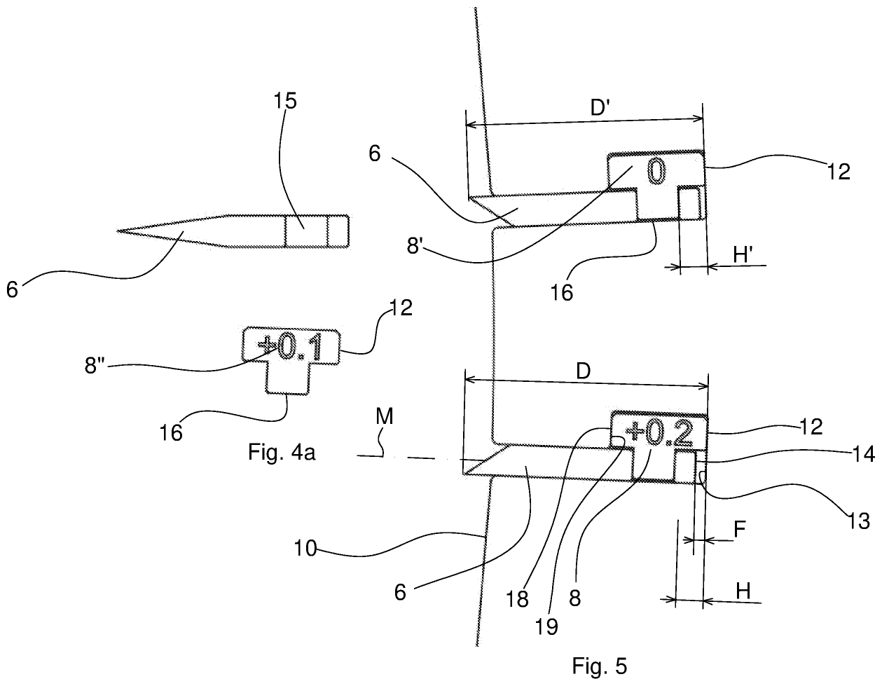

The abutting block 8 may include, in particular, a further abutting face 18 opposite the abutting face 12 (FIG. 5). The further abutting face 18 is obtained on a further external surface of the main body. The further abutting face 18 may include, in particular, a further flat surface (as in the illustrated embodiments). The further abutting face 18 is configured, in particular, to abut on a rest wall 19 of the housing cavity 11 (FIGS. 4 and 5). In one embodiment that is not illustrated, the further abutting face may include a curved surface to abut on a respective curved rest wall of the housing cavity.

The rest wall 19 is opposite the back wall 13. In particular, the rest wall 19 faces the back wall 13.

Each abutting block 8 may display a printed or relief quantitative indication of a deviation of the cutting edge 7 from a reference position indicated by 0, this deviation is linked to the distance H. The deviation may be comprised between 0.05 mm and 0.5 mm. The deviation may be in particular in the order of tenths of millimeters, for example 0.3 mm, 0.25 mm, 0.20 mm, 0.15 mm, 0.10 mm. In addition, or alternatively, the deviation may be, in particular, of the order of hundredths of a millimeter, for example 0.05 mm, 0.04 mm, 0.03 mm, 0.02 mm, 0.01 mm. The quantitative indication of the protrusion of the cutting edge 7 makes the choice of the abutting block 8 and the assembly of the modular insert 5 particularly intuitive.

The overall dimension of the abutting block 8 is of the order of tenths of millimeters, which makes it easy for an operator to handle the abutting block 8. The operator, to adjust a relatively reduced deviation can easily handle a component having suitable dimensions for a manual operation.

The housing cavity 11 may have, in particular, an “L”-shaped section, the section being taken on a reference plane orthogonal to the cross section of the support body 9. A first cavity segment of the “L” section opens on the peripheral edge 10 of the support body. Into this first segment, the cutting element 6 is insertable so that the cutting edge 7 thereof exits from the peripheral edge. A second cavity segment extends transversely, in particular orthogonally, from the first cavity segment. The first cavity segment extends transversely to the advancement direction T, in particular along the radial direction. The second cavity segment is shaped to house, with relatively reduced clearance, the abutting block 8. The back wall 13 and the rest wall 19 both bound the second cavity segment.

The housing cavity 11 may pass through the cross section of the support body 9 (as in the illustrated embodiments). In one embodiment that is not illustrated, the housing cavity is blind, i.e. is not a through cavity with respect to the cross section of the support body 9.

The cutting device 1 may include, in particular, a layer structure, in which the at least one horizontal blade 3, 4 and the support body are stacked along a vertical direction Z. The at least one horizontal blade 3, 4 may include, in particular, a first horizontal blade 3 arranged for performing one or more horizontal cuts at a first height and a second horizontal blade 4 arranged for performing one or more horizontal cuts at a second height that is different from the first height. The first height and the second height are measured along the vertical direction Z (or along the longitudinal axis C of the cap 2).

The first horizontal blade 3 and second horizontal blade 4 may be spaced vertically apart from one another. In particular, the first horizontal blade 3 may be positioned at a vertical height that is greater than a height of the second horizontal blade 4.

The support body 9 may be interposed between the first horizontal blade 3 and the second horizontal blade 4 to prevent an undesired vertical movement of the modular insert 5. In an alternative embodiment that is not illustrated, one or more locking bodies may be provided that are arranged as sandwich with the support body to lock the modular insert 5 vertically.

In other words, the support body 9 may be arranged in a zone included vertically between the first horizontal blade 3 and the second horizontal blade 4.

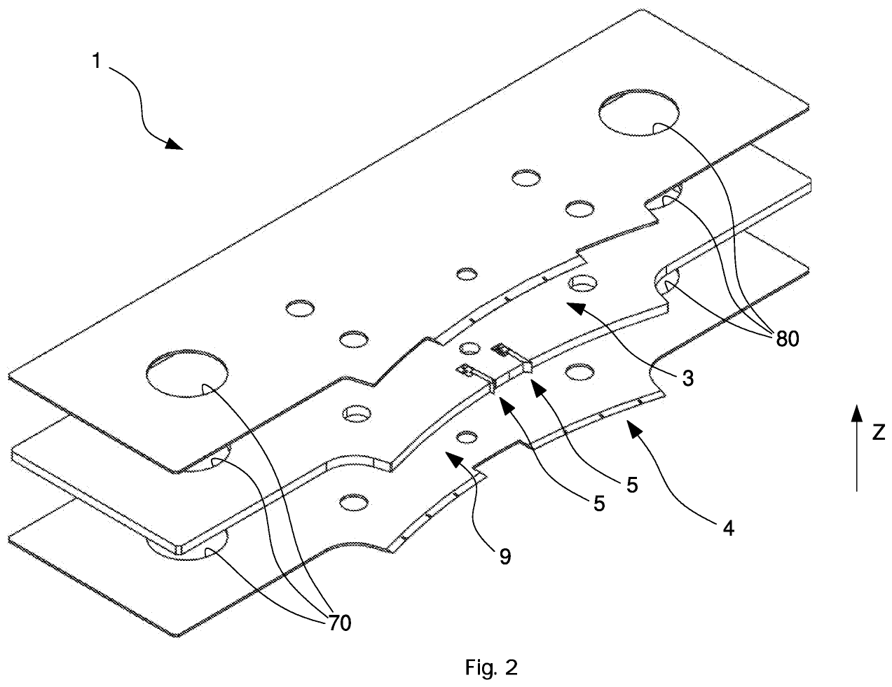

The support body 9 and the at least one horizontal blade 3, 4 may be fixed together (and with a support frame outside the cutting device 1) by a fixing device (not shown). The fixing device may be configured, in particular, to pass through fitting holes 70, 80 (shown for example in FIG. 2).

In a further embodiment that is not illustrated, the modular insert 5 may be fixed with respect to the support body 9 by a further fixing device (not shown).

The fixing device and/or the further fixing device may include, for example threaded elements like screws or bolts.

The cutting device 1 may include, in particular, at least two cutting elements 6 that are interchangeable between one another. Each cutting element 6 may have the cutting edge 7 thereof sharpened on only one side or on both sides.

As mentioned, the cutting element 6 may have the cutting edge 7 tilted with respect to the vertical direction Z.

It is nevertheless possible to use cutting edges 7 of the cutting element 6 configured to perform partially vertical and partially oblique cuts.

The cutting device 1 may include, in particular, a guide member (not shown) arranged for contacting an external portion of the cap 2 and rotating the cap 2 during the advancement of the spindle along the advancement path. The guide member may include, in particular, a knurled section facing in use the spindle. This knurled section is configured to engage suitably with the external portion of the cap 2 and rotate the cap 2 around the longitudinal axis C.

Alternatively, or additionally, the guide member may include, in particular, portions of blades or portions of cutting edges of the cutting device 1 arranged for enabling the cap 2 to roll and at the same time incisions to be made on the cap 2. In other words, the cap 2 may roll on the blades of the cutting device 1 (or equivalently on the cutting portion) whilst the incisions are made on the cap.

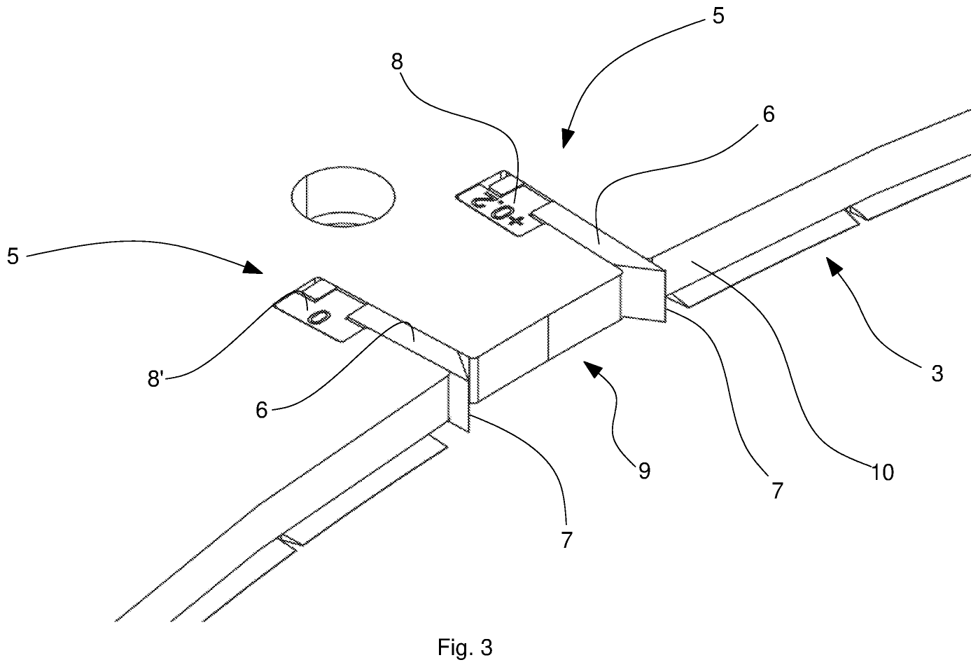

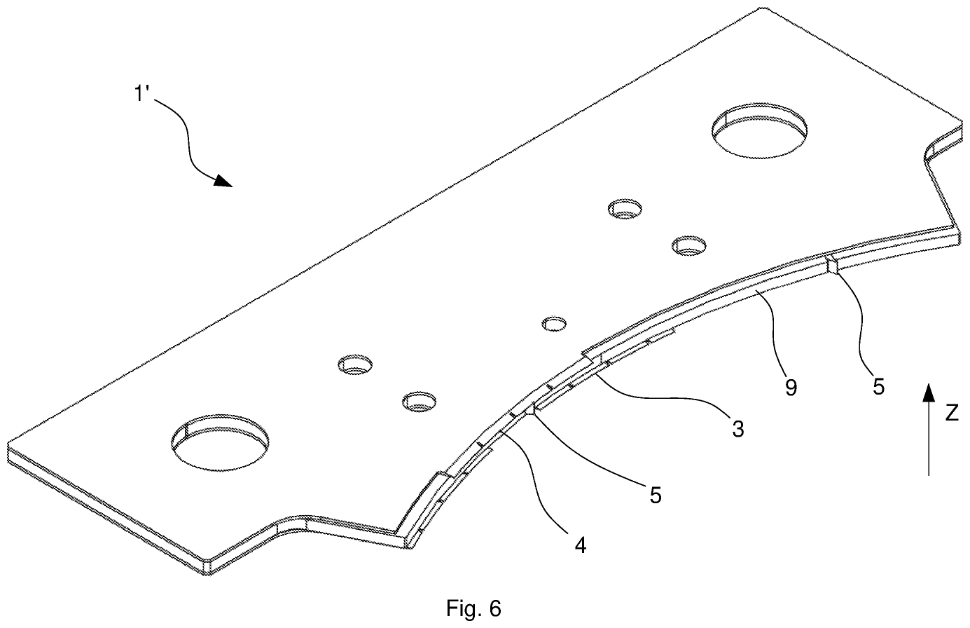

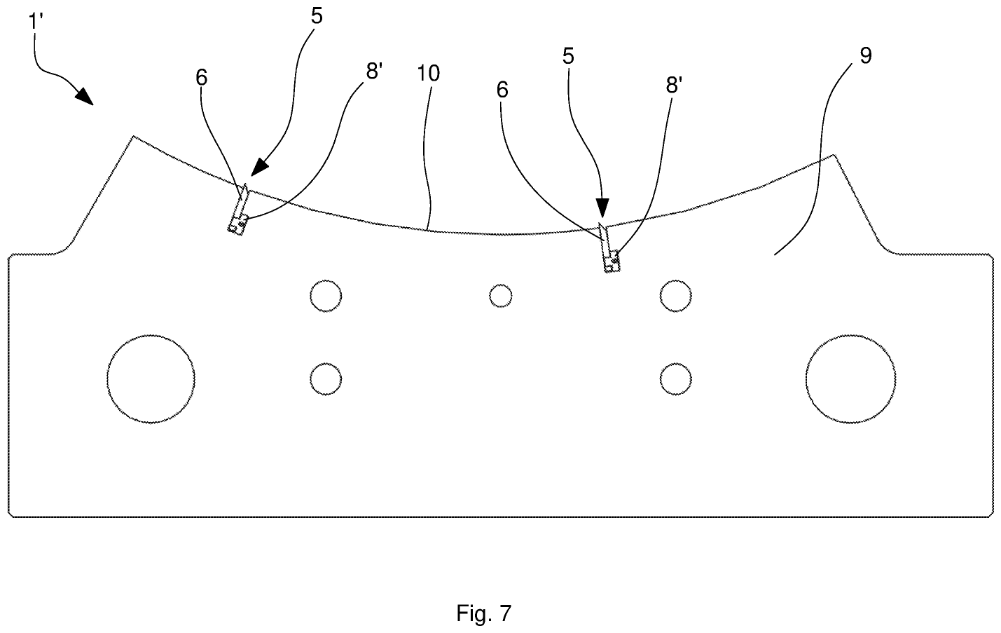

With reference to FIGS. 1, 2, 3 and to FIGS. 6 and 7, the cutting device 1′ according to the second embodiment has modular inserts 5 (or equivalently the cutting edges 7 for vertical or oblique incisions) arranged more distant from the modular elements 5 (cutting edges 7) of the cutting device 1 according to the first embodiment. The first embodiment 1 and the second embodiment 1′ of the cutting device are configured to make the same cutting geometry on the cap; in the second embodiment, however, one of the modular inserts 5 (cutting edges 7) is moved (“dephased”) by a 360° revolution of a cap with respect to the respective position in which the modular insert 5 is located in the first embodiment of the cutting device 1.

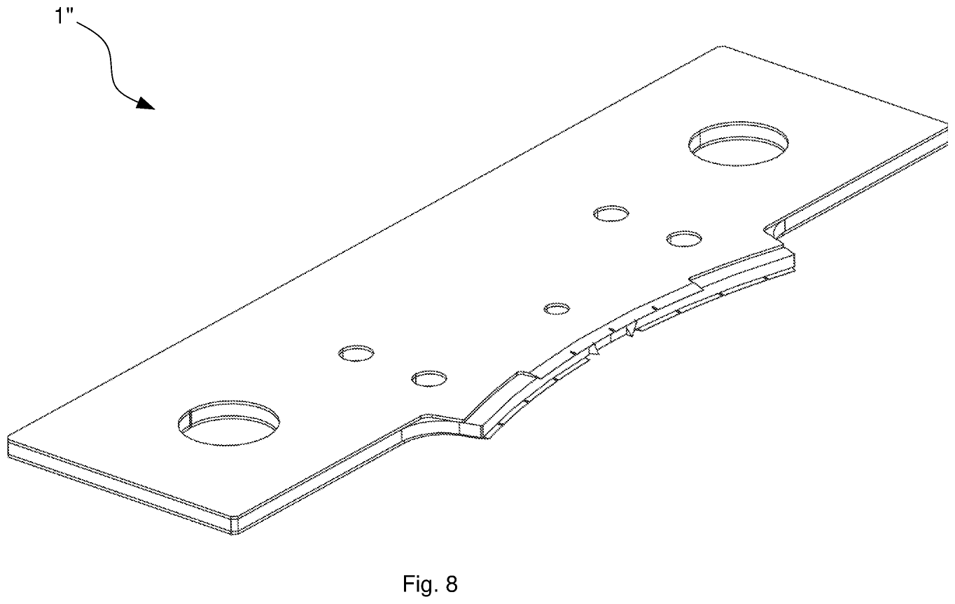

With reference to FIGS. 8, 9, 11 and 12, a cutting device 1″ according to a third embodiment is provided, in which the cutting elements 6 have cutting edges 7 that are tilted with respect to the vertical direction Z. These cutting edges 7 may have tilts that are different from one another, in particular opposite one another.

The disclosed cutting device 1, 1′, 1″ may be assembled by an assembly method disclosed below.

The assembly method may include a step of providing a plurality of interchangeable abutting blocks 8, 8′, 8″, 8′, 8″″.

After providing the plurality of abutting blocks 8, 8′, 8″, 8′″, 8″″, one of these abutting blocks may be selected on the basis of the overall desired dimension D that it is desired that the modular insert 5 has (or on the basis of the depth that it is desired to obtain with this modular insert 5).

Once the desired abutting block 8 has been chosen, the abutting block 8 may be coupled with a cutting element 6 to form (compose) the modular insert 5.

Once the modular insert 5 has been formed, the same may be inserted into the housing cavity 11 of the support body 9. Alternatively to the step of inserting the modular insert 5 into the housing cavity 11, the modular insert 5 may be formed (or the abutting block 8 may be coupled with the cutting element 6) directly inside the housing cavity 11. For example, the cutting element 5 (in the specific embodiments from the top or transversely with respect to the vertical axis Z) may be first inserted into the housing cavity 11, and subsequently the chosen abutting block 8 may be inserted (in the specific embodiments from the top with respect to the vertical axis Z).

In the specific embodiments illustrated, the abutting block 8 may be inserted into the housing cavity 11 along a direction parallel to the cross section of the support body 9. In other non-illustrated embodiments, the abutting block may be inserted into the housing cavity according to different directions.

The assembly method may include, in particular, a step of locking vertically the modular insert 5 with respect to the support body 9. This step of locking vertically may be performed by locking vertically the modular insert 5 (inserted into the housing cavity 11) between the two horizontal blades 3, 4.

Further, the assembly method may include, in particular, a step of choosing the cutting element 6 from a plurality of cutting elements 6. The cutting elements 6 may include cutting elements 6 with the cutting edges more or less tilted with respect to the vertical direction Z.

An embodiment is shown below by way of a non-limiting example of how the cutting device 1 may be assembled.

An operator, on the basis of the geometry of the incisions to be made on the cap, chooses the horizontal blades 3, 4, the support body 9 and the cutting elements 6. Now, on the basis of the desired depth of the oblique or vertical cut that it is desired to obtain, the operator chooses for each cutting element 6 an abutting block 8. The chosen abutting blocks may be different (indicated with 8 and 8′) as in the example in FIG. 5, or the same (both indicated with 8′) as in the example in FIG. 7.

The operator may arrange the support body 9 above the second horizontal blade 4 and then insert into each housing cavity 11 the respective cutting element 6. Now, the operator may insert, for example manually, each abutting block 8 into the respective housing cavity 11 by coupling the coupling protrusion 16 with the coupling slot 15. At this point, the movement of each modular insert 5 in a plane transverse to the thickness of the support body 9 is locked. Subsequently, the operator may arrange the first horizontal blade 3 above the support body 9 and fix the modular insert by the fixing device.

It is noted that using modular inserts for vertical or oblique cuts permits independent adjustment of the position, in particular of the depth, of the various cutting edges or blades and enables the penetration of the single cutting edges or blades to be adjusted independently.

Further, using the modular inserts according to the invention enables wear to the single cutting edges or blades to be compensated effectively, for example, but not restrictively, for cutting apparatuses that are suitable for making caps of tethered type, in which the various cutting edges cut the cap into areas of different angular extent, with different cap thicknesses, a differentiated adjustment between the cutting edges is possible.

Also, the particular conformation of the cutting device, particularly of the abutting block, and the indication of the protrusion of the cutting edge, enable a user to fit the cutting device comfortably and intuitively.

Further, the constructional simplicity and reduced number of the components of the cutting device, in particular of the abutting block and of the cutting element, enable a cutting device to be provided that is extremely flexible compared with a production change and/or a maintenance intervention, making such tasks rapid and simple.

1. Cutting device configured to cut a cap intended to close a container, said cutting device including:
a support member to support at least one horizontal blade configured to perform at least one circumferential cut on the cap rolling on said cutting device along an advancement direction;
at least one modular insert supported by said support member to perform at least one vertical or oblique cut on the cap; said at least one modular insert including at least one cutting element provided at an end thereof with a cutting edge, and at least one abutting block which is interchangeable, and which is couplable with said cutting element to fix a dimension of said at least one modular insert, said dimension being a length between said cutting edge and an abutting face of said at least one abutting block;
said support member including a support body which includes, on a peripheral edge thereof and for each modular insert, a housing cavity, said modular insert being insertable in, and removable from, said housing cavity which is shaped for receiving said modular insert so that said cutting edge protrudes from said peripheral edge, said abutting face being configured to abut a back wall of said housing cavity so that a rear end of said cutting element opposed to said cutting edge is spaced from said back wall.

2. Cutting device according to claim 1, including at least two abutting blocks which are interchangeable to obtain dimensions different to each other.

3. Cutting device according to claim 2, wherein said cutting element extends along a main direction between said rear end and said cutting edge, said cutting element including a coupling slot transverse to said main direction, said at least one abutting block including a coupling protrusion arranged for being inserted at least partially in said coupling slot to form said modular insert so as to prevent a displacement between said at least one abutting block and said cutting element at least in parallel to said main direction.

4. Cutting device according to claim 3, wherein said at least two abutting blocks have distances between said coupling protrusion and said abutting face different to each other.

5. Cutting device according to claim 1, wherein said at least one abutting block includes a further abutting face opposite to said abutting face and shaped for abutting an abutting wall of said housing cavity, said abutting wall being opposite to said back wall.

6. Cutting device according to claim 1, including a layer structure in which said at least one horizontal blade and said support body are stacked along a vertical direction.

7. Cutting device according to claim 6, wherein said at least one horizontal blade includes a first horizontal blade arranged for performing one or more horizontal cuts at a first height and a second horizontal blade arranged for performing one or more horizontal cuts at a second height different to the first height; and wherein said support body is interposed between said first horizontal blade and said second horizontal blade so as to prevent an undesired vertical displacement of said at least one modular insert.

8. Cutting device according to claim 1, wherein said support body is plate shaped; said at least one modular insert being, in particular, insertable in, removable from, said housing cavity along a direction parallel to a transverse thickness of said plate-shaped support body.

9. Cutting device according to claim 8, wherein said housing cavity has an L-shaped section, said section being taken on a reference plane orthogonal to a transverse thickness of said plate-shaped support body.

10. Cutting device according to claim 8. wherein said housing cavity is pass-through with respect to a transverse thickness of said plate-shaped support body.

11. Cutting device according to claim 8, wherein said housing cavity is blind with respect to a transverse thickness of said plate-shaped support body.

12. Cutting device according to claim 1, including at least two cutting elements which are interchangeable having a cutting edge sharpened on a side only and/or on two sides.

13. Cutting apparatus for cutting a cap including:
an advancement path travelable by the cap;
a cutting area arranged in said advancement path;
a cutting device arranged in said cutting area to cut the cap;
a carousel provided with a plurality of transport units, each of which is configured to engage with the cap and transport the cap along said advancement path;
wherein said cutting device is realized according to claim 1.

14. Assembly method for assembling a cutting device, the method including the steps of:
providing a cutting device according to claim 1;
providing a plurality of abutting blocks which are interchangeable;
selecting one abutting block among the plurality of abutting blocks based on a desired dimension of said at least one modular insert;
coupling the selected modular block with the cutting element to form the modular insert;
inserting the modular insert in the housing cavity of the support body;
fixing vertically the modular insert with respect to the support body.

15. Assembly method according to claim 14, including inserting the selected abutting block in the housing cavity along a direction parallel to the transverse thickness of the support body which is plate-shaped, after inserting the cutting element in the housing cavity.
